(19) United States
(12) Patent Application Publication
(10) Pub. No.: US 2026/0356330 A1
(43) Pub. Date: Nov. 12, 2026

(54) METHODS FOR STOP SIGN AWARENESS AT INTERSECTIONS FOR CROSS TRAFFIC ASSISTANCE AND SYSTEMS THEREOF

(71) Applicant: Daimler Truck North America LLC, Portland, OR (US)

(72) Inventors: Quyen DUCHESNEAU, Portland, OR (US); Lowell BROWN, Portland, OR (US); Paul PETTY, Portland, OR (US); Derek ROTZ, Portland, OR (US); Cristin PAUN, Portland, OR (US); Anand PRASANNA, Portland, OR (US); Harsha ALVA, Portland, OR (US); S. MRUDULA, Portland, OR (US)

(73) Assignee: Daimler Truck North America LLC, Portland, OR (US)

(21) Appl. No.: 19/134,609

(22) PCT Filed: Dec. 1, 2023
(86) PCT No.: PCT/US2023/082022

§ 371 Date: May 30, 2025

(30) Foreign Application Priority Data
Dec. 2, 2022 (IN) 202241069628

(51) Int. Cl. B60T 7/12; B60Q 9/00; G06V 10/764; G06V 20/58

(52) U.S. Cl. CPC B60T 7/12; B60Q 9/00; G06V 10/764; G06V 20/582; B60T 2210/24; B60T 2210/32; B60T 2210/36; B60T 2250/02; B60T 2250/04

(57) ABSTRACT

Methods, devices, and systems for vehicle unintended intersection entry prevention are disclosed. In examples, a first remaining distance from a vehicle to a stop sign object is monitored. An optical warning is output upon determining a detection threshold distance from the stop sign object has been reached based on the monitored first remaining distance. A second remaining distance to the stop sign object is compared to a predicted stopping distance. The second remaining distance is determined based on the detection threshold distance and a vehicle distance traveled following determination of the detection threshold distance, and the predicted stopping distance is determined based on a current vehicle velocity and a determined braking operation applied to the vehicle. The braking operation is actuated to prevent the vehicle from traveling past a stopping location associated with the stop sign object, responsive to the comparison indicating a point of no return has been reached.

### CROSS-REFERENCE TO RELATED APPLICATION

This application claims priority to India patent application Ser. No. 202241069628, filed Dec. 2, 2022 which is incorporated by reference herein in its entirety.

### FIELD

This technology generally relates to vehicle driving assistance systems and, more particularly, to methods and devices for avoidance of unintended vehicle entry into an intersection.

### BACKGROUND

Driving assistance systems are increasingly provided on consumer and commercial vehicles to reduce the chances of undesired vehicle operating circumstances. Some exemplary driving assistance systems include antilock braking, electronic stability control, adaptive cruise control, lane keeping assist, blind spot warning, parking assist, forward collision warning, and emergency braking systems capable to reduce or avoid impact with objects in a vehicle's path. Modern vehicles are equipped with numerous sensors that inform these driving assistance systems to help effectively assist with vehicle control.

Traffic signs are road signs established according to road traffic regulations that serve to influence or regulate the traffic flow. Road signs have been internationally standardized by the Vienna Convention on Road Signs so that they can be more easily observed and interpreted. For example, stop signs have a distinctive contour (i.e., octagon) that is uniform across many countries so that a clear interpretation of that signs is possible, even if only its outline or its contour is known.

Despite driving assistance systems and other measures including traffic sign standardization, driving continues to be a potentially hazardous endeavor. Intersections where traffic signs (e.g., stop signs) are posted are one example where undesirable interactions between a vehicle and one or more other vehicles, pedestrians, etc., may occur. Current active vehicle features are insufficient to avoid instances of unintended entry of a vehicle into an intersection, including those involving relatively large commercial vehicles (e.g., class 6-8 trucks) which can be challenging to stop quickly in the event of a need to do so. For example, there are scenarios where vehicles with active braking assistance features do not effectively brake the vehicle in situations where commanded braking can reduce or completely avoid unintended entry of the vehicle into an intersection (that is, past a desired stopping point).

### SUMMARY

In a first aspect, a method for preventing unintended vehicle entry into an intersection comprises predicting that a vehicle may not come to a halt at a stopping location associated with a stop sign object along a path the vehicle is currently traveling unless a braking operation is commanded; issuing an alarm to alert an operator of the vehicle that the braking operation is commencing or is about to commence; and actuating the braking operation to bring the vehicle to a halt at the stopping location.

In a second aspect, a method for stopping a vehicle at a stopping location comprises monitoring a first remaining distance from the vehicle to a stop sign object; outputting an optical alert subsequent to determining a detection threshold distance from the stop sign object has been reached, the detection threshold distance based at least in part on the first remaining distance; determining a second remaining distance from the vehicle to the stop sign object, the second remaining distance less than the first remaining distance; determining a predicted stopping distance based on a predetermined set of braking operation parameters; comparing the second remaining distance to the predicted stopping distance to determine whether a point of no return (PONR) has been reached; and actuating a braking operation responsive to a determination that the PONR has been reached to ensure that the vehicle stops within a predetermined distance before reaching the stopping location.

In a third aspect, disclosed is a stop sign awareness at intersections (SSAI) device, comprising a memory having instructions stored thereon; and at least one processor coupled to the memory and configured to execute the stored instructions to cause the SSAI device to carry out the first aspect.

In a fourth aspect, disclosed is a SSAI device, comprising a memory having instructions stored thereon; and at least one processor coupled to the memory and configured to execute the stored instructions to cause the SSAI device to carry out the second aspect.

In a fifth aspect, disclosed is an unintended entry into an intersection avoidance system, comprising a global positioning system (GPS) device coupled to a vehicle, a brake system controller, an instrument panel display device; an audio output device, and the SSAI device according to the third aspect.

In a sixth aspect, disclosed is an unintended entry into an intersection avoidance system, comprising a GPS device coupled to a vehicle, a brake system controller, an instrument panel display device; an audio output device, and the SSAI device according to the fourth aspect.

In a seventh aspect, disclosed is a vehicle comprising the unintended entry into an intersection avoidance system of the fifth aspect or the sixth aspect.

The technology described and illustrated by way of the examples herein provides a vehicle crash avoidance system with an improved active safety cascade that more effectively detects stop sign objects and prevents unrestrained entry by vehicles into an intersection to thereby reduce vehicle crashes and associated injuries. The crash avoidance system disclosed herein provides an optical and acoustic warning phase followed by a haptic braking and, optionally, an emergency braking phase that more effectively makes the vehicle operator aware of upcoming deceleration requests, and allow the vehicle operator to regain control. The timing of the phases of the active safety cascade of this technology is advantageously determined based on a PONR determination and ramp periods and associated deceleration rates in order to more effectively prevent the unintended entry of the vehicle into an intersection.

### BRIEF DESCRIPTION OF THE DRAWINGS

FIG. 1 is a block diagram of an unintended intersection entry prevention system that includes a stop sign awareness at intersections (SSAI) device;

FIG. 2 is a block diagram of an exemplary SSAI device;

FIG. 3 is a flowchart of an exemplary method for vehicle unintended intersection entry prevention;

FIG. 4 is a diagram of an exemplary analysis of a detection threshold distance condition when a relevant stop sign object is along a straight path of travel for a vehicle;

FIGS. 5A-5B illustrate an exemplary analysis of a detection threshold distance condition when a relevant stop sign object is along a path of travel for a vehicle that is at least partially curved;

FIG. 6 is a diagram of an exemplary predicted stopping distance calculation for an active braking cascade that includes haptic braking;

FIG. 7 is a diagram of an exemplary predicted stopping distance calculation for an active braking cascade that includes haptic and emergency braking;

FIG. 8 is a diagram of an exemplary method for avoidance of unintended vehicle entry into an intersection;

FIG. 9 is a block diagram of a first level of an exemplary SSAI model architecture;

FIG. 10 is a block diagram of a second level of the exemplary SSAI model architecture of FIG. 9;

FIG. 11 is a block diagram of a third level of the exemplary SSAI model architecture of FIG. 9;

FIG. 12 is a block diagram of a portion of the third level of the exemplary SSAI model architecture of FIG. 11;

FIG. 13 is a block diagram of another portion of the third level of the exemplary SSAI model architecture of FIG. 11;

FIG. 14 is a block diagram of yet another portion of the third level of the exemplary SSAI model architecture of FIG. 11; and

FIG. 15 is a block diagram of a fourth level of the exemplary SSAI model architecture of FIG. 9.

### DETAILED DESCRIPTION

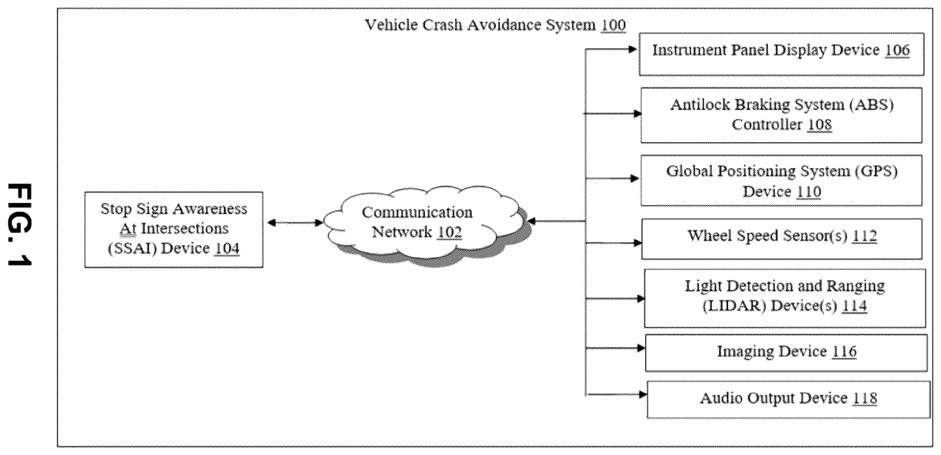

Referring to FIG. 1, an exemplary vehicle unintended entry into intersection avoidance system 100 is illustrated. The various components of the system 100 can be mechanically and/or electrically coupled to a vehicle, such as a commercial truck, and can be communicatively coupled together via a communication network 102, which can include one or more wired and/or wireless connections. One or more of the components of the system 100 can be integral with or separate from one or more other of the components. Additionally, the system 100 can include other components, such as one or more sensors or driving assistance devices, for example, which are not described herein.

In embodiments, the unintended entry into intersection avoidance system 100 is a system that is additional to an active braking assistance (ABA) system configured to control braking and one or more alerts in response to one or more objects in a vehicle's path. In embodiments herein, such an ABA system has priority over the unintended entry into intersection avoidance system 100.

This technology provides advantages including improved avoidance of unintended entry of a vehicle into an intersection via a more effective active braking cascade including optical and acoustic warnings, and active haptic and, in embodiments, emergency braking. Discussed herein, haptic braking refers to braking that can be perceived less by a vehicle operator and/or passengers of the vehicle, as compared to emergency braking. Accordingly, emergency braking refers to braking that is perceived more (i.e., is more readily perceived) by a vehicle operator and/or passengers of the vehicle. In embodiments, haptic braking refers to commanded deceleration of a vehicle between about −1 m/s² and −4 m/s², for example between about −2 m/s² and −4 m/s², for example about −3 m/s². In embodiments, emergency braking refers to braking that is between about −5 m/s² and about −10 m/s², for example between about −6 m/s² and about −8 m/s², for example about −6 m/s².

The technology reduces a likelihood that a vehicle will unintendedly and, undesirably, enter an intersection without, e.g., proper obeying of a posted traffic sign. In this way, undesired interactions between the subject vehicle and other vehicles, pedestrians, and the like, are reduced or avoided altogether. Advantageously, effective vehicle lifetime is improved, costs are reduced, and adverse vehicle-vehicle, vehicle-pedestrian, etc., are reduced or avoided.

The vehicle unintended entry into an intersection avoidance system 100 in this particular example includes a stop sign awareness at intersections (SSAI) device 104 that is coupled via the communication network 102 with an instrument panel display device 106, an antilock braking system (ABS) controller 108, a global positioning system (GPS) device 110, wheel speed sensor(s) 112, light detection and ranging (LIDAR) device(s) 114, an imaging device 116, and an audio output device 118, although other devices can be coupled to the SSAI device 104 in other examples. The SSAI device 104 may perform any number of functions, including recognizing and/or identifying stop sign objects associated with an upcoming intersection on a travel path of a vehicle and communicating with various devices to implement a warning and active braking cascade to prevent the vehicle from unrestrained entry into the intersection.

The SSAI device 104 can determine that a stop sign object is associated with an upcoming intersection along a vehicle's path using a map database 208 and the GPS device 110. The GPS device 110 can be a GPS transceiver in this example, which is attached to the front of a vehicle or at a known offset distance from the front of the vehicle. The GPS device 110 is configured to communicate with a plurality of satellites to determine positional information (e.g., geolocation), which is communicated to the SSAI device 104. The SSAI device 104 then correlates the positional information with the map database 208 to identify a nearest or most relevant stop sign object stored in the map database 208.

In an additional or alternative example, the SSAI device 104 can use the imaging device 116 (e.g., an image sensor or camera) to capture imaging data, which is analyzed by the SSAI device 104 (e.g., by applying a trained machine learning model) to recognize a stop sign object at an upcoming intersection. Additional or alternative examples further comprise the reliance on LIDAR device(s) 114 which may be analyzed by the SSAI device to recognize a stop sign object at an upcoming intersection. In yet other additional or alternative examples, the imaging device 116 is used to confirm the identification of a stop sign object that is made via the GPS device 110 and map database 208, and/or LIDAR devices 114, and other permutations and methods of identifying or recognizing a stop sign object can also be used in other examples.

The SSAI device 104 subsequently uses the GPS device 110 to analyze the remaining distance of the vehicle to the stop sign object before switching to a more granular remaining distance calculation based on odometry and data retrieved from the wheel speed sensor(s) 112 after a detection threshold distance has been reached. The wheel speed sensor(s) 112 can be active sensors that record signals through a magnetic pulse sensor, although passive sensors can also be used. The SSAI device 104 can obtain the wheel speed data from the wheel speed sensor(s) 112 directly or via the ABS controller 108.

In another example, other sensors such as the LIDAR device(s) 114 can be used to determine the more granular distance after the detection threshold distance has been reached. The LIDAR device(s) 114 in this example are configured to emit ultraviolet, visible, or near infrared light and to detect the energy reflected by the stop sign object. The distance to the stop sign object can be determined based on the speed of light and by recording the time between transmitted and backscattered pulses. In yet other examples, other permutations of odometry, LIDAR, camera, and/or other devices can be used to determine the remaining distance to the stop sign object.

Upon reaching the detection threshold distance, the SSAI device 104 communicates with the instrument panel display device 106 to output an optical warning regarding the upcoming stop sign object and intersection. The optical warning can be an indicator light and the instrument panel display device 106 can be a light emitting diode (LED) display device and/or a liquid crystal display (LCD) device, for example, although any type of display device can be used.

If the vehicle subsequently reaches a point of no return (PONR), as described and illustrated in more detail below, the SSAI device 104 is configured to communicate with the audio output device 118 (e.g., a vehicle speaker) to emit an audible warning regarding the upcoming stop sign object and associated intersection. The SSAI device 104 subsequently (e.g., after a predefined response time has elapsed), initiates haptic braking via communication with the ABS controller 108. The ABS controller 108 in this example includes a microprocessor or other processing device and is configured to actuate brakes of the vehicle to reduce the wheel speed.

After a period of haptic braking, the SSAI device 104, in some embodiments, communicates with the ABS controller 108 to instruct the ABS controller 108 to actuate emergency braking in order to bring the vehicle to a stop in advance of the stop sign object and associated intersection. Exemplary particular triggers and warnings and active braking cascades will be described and illustrated in more detail below. In some embodiments, a vehicle operator, fleet manager, etc., can control how the SSAI device 104 operates with respect to selection of haptic and/or emergency braking routine usage. For example, and without limitation, a vehicle operator may prefer haptic braking, and may set the SSAI device 104 to preferentially rely on haptic braking whenever possible, in lieu of emergency braking. It is to be understood that as haptic braking increases proportionally to emergency braking, total stop time and total stopping distance increases. Of course, as emergency braking increases proportionally to haptic braking, total stop time and total stopping distance decreases. It is recognized that increased emergency braking can result in greater (e.g., faster) wear and tear on braking and other vehicle components. Accordingly, in embodiments the SSAI parameters can be set based on driver habits, for example learned driver habits as a function of time. In a non-limiting and illustrative example, a driver who relies on emergency braking too often may be required by a fleet operator to adjust the SSAI device 104 (e.g., via the instrument panel display device 106) such that haptic braking is proportionally increased, to reduce wear and tear on the vehicle.

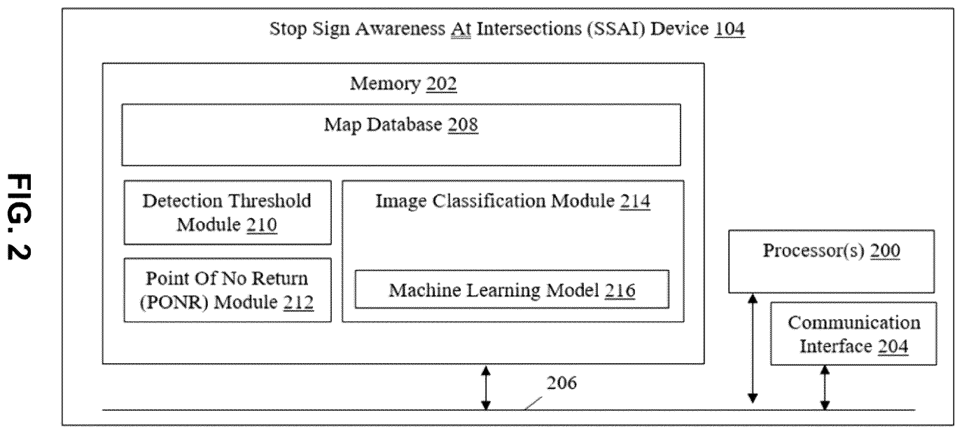

Referring to FIG. 2, the SSAI device 104 in this example includes processor(s) 200, a memory 202, and a communication interface 204, which are coupled together by a bus 206, although the SSAI device 104 can include other types or numbers of elements in other configurations. The communication interface 204 of the SSAI device 104 operatively couples and communicates between the SSAI device 104 and the instrument panel display device 106, ABS controller 108, GPS device 110, wheel speed sensor(s) 112, LIDAR device(s) 114, imaging device 116, and audio output device 118 that are coupled to the communication network 102.

The processor(s) 200 of the SSAI device 104 may execute programmed instructions stored in the memory 202 of the SSAI device 104 for any number of the functions identified above and described and illustrated in more detail below. The processor(s) 200 may include one or more central processing units (CPUs) or general purpose processors with one or more processing cores, for example, although other types of processor(s) 200 can also be used.

The memory 202 of the SSAI device 104 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium, which is read from and written to by a magnetic, optical, or other reading and writing system that is coupled to the processor(s) 200, can be used for the memory 202.

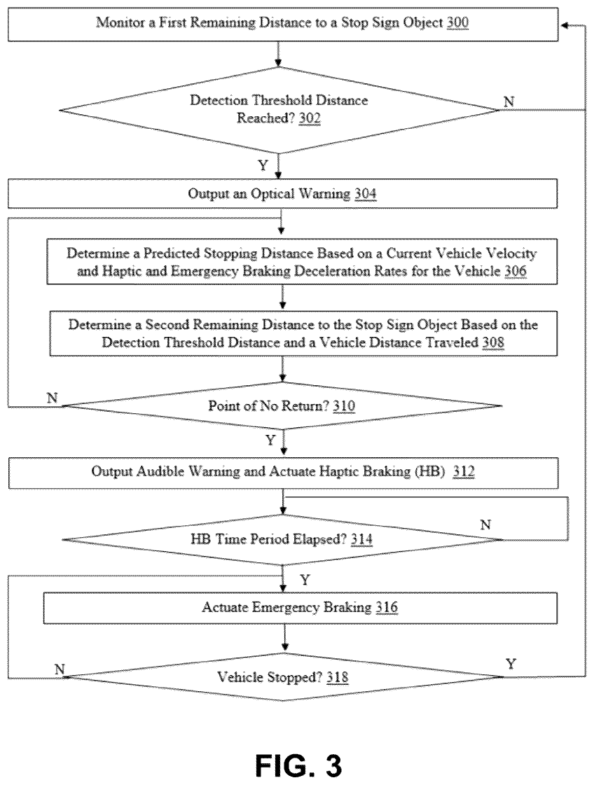

Accordingly, the memory 202 of the SSAI device 104 can store one or more modules that can include computer executable instructions that, when executed by the SSAI device 104, cause the SSAI device 104 to perform actions, such as to transmit, receive, or otherwise process messages (e.g., database queries or device commands), and to perform other actions described and illustrated below (e.g., with reference to FIG. 3). The modules can be implemented as components of other modules. Further, the modules can be implemented as applications, operating system extensions, and/or plugins, for example.

In this particular example, the memory 202 of the SSAI device 104 includes the map database 208, a detection threshold module 210, a point of no return (PONR) module 212, and an optional image classification module 214 with a machine learning model 216, the operation of which is described and illustrated in more detail below with reference to FIG. 3. Other modules also can be contained within the memory 202 in other examples. The map database 208 can be a hard-coded database that includes information regarding the location of roads, stop sign objects, and intersections, for example. In other examples, the map database 208 can be located remotely from the SSAI device 104, which can communicate with the map database 208 via a wireless network.

The image classification module 214 can analyze imaging data obtained from the imaging device 116 to determine whether a stop sign object is present in the image, indicating an upcoming intersection at which the vehicle will be required to stop. In this particular example, the image classification module 214 applies a trained machine learning model 216 to the imaging data in order to classify the image as including a stop sign object. The machine learning model 216 can be generated via supervised or unsupervised training, and may be a binary classifier, such as a Support Vector Machine (SVM), Logistic Regression, Random Forest, or XGBoost, for example, although other types of machine learning models can also be used in other examples.

The detection threshold module 210 is configured to use geolocation information from the GPS device 110 and the map database 208 to continuously calculate the location of the vehicle as compared to a detection threshold distance from the nearest stop sign object. In some examples, the detection threshold distance can be a predefined value and, in other examples, the detection threshold distance can be dynamically determined based on any number of parameters including the current vehicle velocity, vehicle weight, and/or information regarding proximal traffic or the particular upcoming intersection, for example. In embodiments, the detection threshold distance is determined, at least in part, based on an assumption that the vehicle is fully loaded (i.e., within a predetermined threshold of a maximum weight capacity). It is herein recognized that setting the detection threshold distance as a function of vehicle weight, where the vehicle is assumed to be fully loaded, can, in embodiments, improve effectiveness of the herein disclosed methodology. In other embodiments, detection threshold distance may be dynamically calculated, at least in part, as a function of vehicle weight, where vehicle weight is calculated dynamically with some level of precision (e.g., estimated weight within 3-5% of actual). The detection threshold module 210 is therefore configured to trigger the optical warning and associated active braking cascade, as well as a switch to more granular remaining distance measurement, when the detection threshold distance from the stop sign object has been reached.

The PONR module 212 is configured to continuously analyze the remaining distance to the stop sign object, determined using a relatively granular method (e.g., odometry), and the currently vehicle velocity to determine whether the vehicle has reached a point in which it will enter the intersection associated with the stop sign object if the remainder of the active braking cascade (i.e., haptic and, optionally, emergency braking) is not initiated. Accordingly, the PONR module 212 in this example is configured to communicate with the audio output device 118 and the ABS controller 108 to trigger and carry out the remainder of the active braking cascade and prevent the unintended entry of the vehicle into the intersection.

While the SSAI device 104 is illustrated in this example as including a single device, the SSAI device 104 in other examples can include a plurality of devices each having processor(s) (each processor with processing core(s)) that implement one or more steps of this technology. In these examples, one or more of the devices can have a dedicated communication interface or memory. Alternatively, one or more of the devices can utilize the memory 202, communication interface 204, or other hardware or software components of one or more other devices included in the vehicle unintended entry into an intersection avoidance system 100. Additionally, one or more of the devices that together comprise the SSAI device 104 in other examples can be standalone devices or integrated with one or more other devices or apparatuses.

Although the exemplary system 100 with the SSAI device 104, communication network 102, instrument panel display device 106, ABS controller 108, GPS device 110, wheel speed sensor(s) 112, LIDAR device(s) 114, imaging device 116, and audio output device 118 is described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the vehicle unintended entry into an intersection avoidance system 100, such as the SSAI device 104, instrument panel display device 106, ABS controller 108, GPS device 110, wheel speed sensor(s) 112, LIDAR device(s) 114, imaging device 116, or audio output device 118 may be configured to operate as virtual instances on the same physical machine. In other words, one or more of the SSAI device 104, instrument panel display device 106, ABS controller 108, GPS device 110, wheel speed sensor(s) 112, LIDAR device(s) 114, imaging device 116, or audio output device 118 may operate on the same physical device rather than as separate devices communicating through the communication network 102. Additionally, there may be more or fewer SSAI devices, instrument panel display devices, ABS controllers, GPS devices, wheel speed sensor(s), LIDAR device(s), imaging devices, or audio output devices than illustrated in FIG. 1.

The examples may also be embodied as one or more non-transitory computer readable media having instructions stored thereon, such as in the memory 202 of the SSAI device 104, for one or more aspects of the present technology, as described and illustrated by way of the examples herein. The instructions in some examples include executable code that, when executed by one or more processors, such as the processor(s) 200 of the SSAI device 104, cause the processors to carry out steps necessary to implement the methods of the examples of this technology that are described and illustrated herein.

Referring more specifically to FIG. 3, a flowchart of an exemplary method for avoiding unintended entry of a vehicle into an intersection, is illustrated. The method of FIG. 3 is described with reference to FIGS. 1-2 and associated description, as well as remaining figures and associated description thereof, although it should be understood that similar methods may be applied to other systems without departing from the scope of this disclosure. The method of FIG. 3 may be carried out by a controller storing executable instructions in non-transitory memory, for example processor 200 at FIG. 2.

The method of FIG. 3 begins at step 300, where the SSAI device 104 monitors a first remaining distance to a stop sign object. Optionally, the monitoring, and the remainder of the method illustrated in FIG. 3, can be conditioned upon predefined enablement criteria. For example, in implementations including the imaging device 116 attached to the vehicle at a front-facing location, the SSAI device 104 can confirm that the imaging device 116 has traffic sign recognition capabilities up to a particular vehicle speed based on camera performance in order to reinforce confidence in the map database 208.

Other exemplary enablement criteria can include confirmation of one or more of the following: that the vehicle is moving forward, and not at a standstill or moving backward; the current road gradient does not exceed a threshold (i.e., reflecting a relatively steep incline or decline that could impact braking performance); the current road curvature is below a threshold to avoid jack-knifing, for example, due to relatively hard braking during turning maneuvers; the current road curvature is within a predetermined curvature range; that vehicle wipers (e.g., front and or rear windshield wipers) are active and/or active above a preset wiper speed threshold, that the ambient temperature is above a threshold (e.g., −10 °F) and/or within a threshold temperature range (e.g., −10 °F-110 °F, or any range therebetween); that there is a presence of rain, snow, hail, or fog; and/or the current road is of a specified road class (e.g., class 1-3) to avoid city roads or roads that allow relatively high speed, for example. Other types of enablement criteria can be used in other examples.

Accordingly, responsive to an indication that the enablement criteria are satisfied, the SSAI identifies a nearest stop sign object that is along a path of travel of the vehicle using the GPS device 110 coupled to the vehicle and a geolocation of the stop sign object that is retrieved from the map database 208. In other additional or alternative examples, the imaging device 116 can be used to recognize the stop sign object at a visible, upcoming intersection, as described in more detail above. As a representative example, the imaging device 116 can be redundant to the GPS device 110, such that in a case where map database 208 is not yet updated with, e.g., a newly installed stop sign, the imaging device 116 can recognize the stop sign.

In these examples, the SSAI device 104 can apply the machine learning model 216 to classify the image as comprising the stop sign object. Optionally, the SSAI device 104 can then update the map database 208 with a determined geolocation of the stop sign object to facilitate subsequent identification via the map database 208. In some examples, the map database 208 can be updated based on a determined confidence value relating to the classification of the imaging data obtained from the imaging device 116. Optionally, a vehicle operator may be requested to confirm or deny the existence of an imaging device-recognized stop sign, for example via the instrument panel device 106. Other methods for identifying and/or confirming the existence and/or location of the nearest stop sign object can also be used in other examples.

Subsequent to identifying the nearest stop sign object along the current vehicle trajectory, the SSAI device 104 monitors (e.g., continuously determines) the first remaining difference of the vehicle to the stop sign object in step 300 using the GPS device 110 and previously-determined geolocation of the stop sign object. In examples in which the GPS device 110 is utilized, the determination in step 300 can consider the offset of the GPS from the front of the vehicle. In other examples, the LIDAR device(s) 114 can be used in place of, or in addition to, the geolocation-based first remaining distance calculation, and other methods for determining the first remaining distance can also be used.

In step 302, the SSAI device 104 determines whether a detection threshold distance has been reached based on the determined first remaining distance. In some examples, the detection threshold distance can be a calibrated or predefined static distance or time value and in other examples a dynamic detection threshold distance or time can be used that is determined based on a determined current vehicle velocity or other environmental factors (e.g., level of ice, snow, sleet, rain, etc.), for example. In embodiments, detection threshold distance may be additionally or alternatively be determined based on a “worst-case scenario” assumption or set of assumptions, which can serve to bias the methodology to being more stringently and effectively applied for all scenarios. For example, such assumptions can include but are not limited to an approaching curve plus rain and/or snow conditions, maximum vehicle weight capacity (i.e., fully loaded), vehicle traveling downhill at some predetermined downhill grade, and the like.

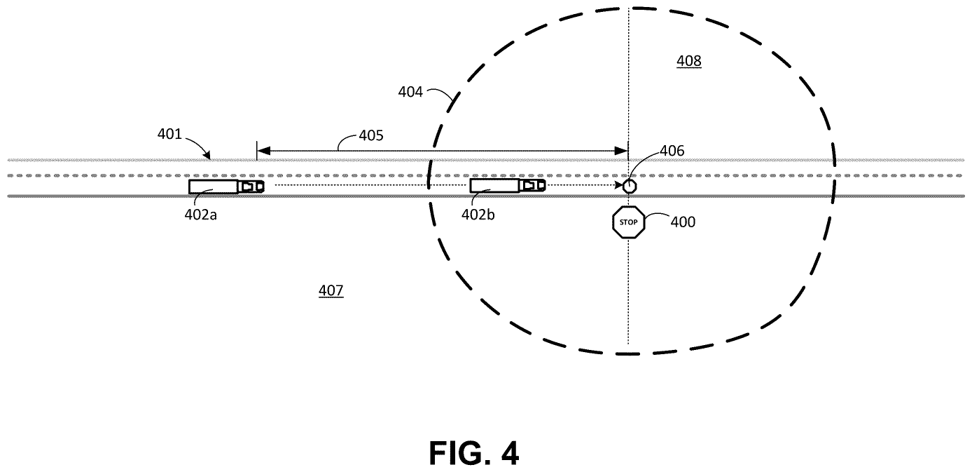

Referring to FIG. 4, a diagram of an exemplary analysis of the detection threshold distance condition in step 302 when the relevant stop sign object 400 is along a straight path of travel for the vehicle 402 is illustrated. In this example, latitude and longitude positions for a current position 401 of the vehicle 402a, 402b and the stop sign object 400, which corresponds to a required stopping location 403, are used along with the below Haversine formula to calculate the first remaining distance (i.e., distance 405) of the vehicle 402 to the stop sign object 400. It is to be understood that vehicle 402a and 402b are the same vehicle, vehicle 402a representing the vehicle at a prior point in time with respect to travel towards stop sign object 400, as compared to vehicle 402b.

$$R = 6371 km = Earth Radius$$

$$( {φ}_{1} , {λ}_{1} ) = ( Latitude\_ 1 , Longitude\_ 1 ) of Ego Position$$

$$( {φ}_{2} , {λ}_{2} ) = ( Latitude\_ 2 , Longitude\_ 2 ) of Relevant Stop Sign Position$$

$$D = 2 * R * {sin}^{- 1} \sqrt{{sin ( \frac{{φ}_{2} - {φ}_{1}}{2} )}^{2} + cos {φ}_{1} * cos {φ}_{2} * {sin ( \frac{{λ}_{2} - {λ}_{1}}{2} )}^{2}}$$

With reference to the above Haversine formula, ego position refers to current position 401, and corresponding latitude and longitudinal coordinates thereof. Latitude and longitude coordinates corresponding to stop sign position 406, are additionally relied upon. D in the above formula corresponds to distance 405.

In this example, the GPS device 110 is used to monitor the distance 405 to the relevant stop sign object 400 and, upon reaching the calibrated detection threshold distance 404, distance travel estimation is switched to additionally or alternatively calculate from high-resolution wheel speed sensor(s) 112. Thus, while the above Haversine formula is an approximation, and the Earth's radius will vary depending on the distance/altitude from the poles or equator, the GPS device 110 can be used as a trigger point in this particular example in which the SSAI device 104 subsequently relies on high-resolution wheel speed sensor(s) 112 for the distance travel estimate. Stated another way, in embodiments, there are e.g., two modes by which the distance 405 to the relevant stop sign object 400 can be determined. In the first mode 407, GPS is relied upon prior to the vehicle 402a crossing detection threshold distance 404, and one or more of GPS and/or wheel speed sensor(s) are relied upon in the second mode 408 which is activated upon the vehicle crossing detection threshold distance 404. Other methods for determining the first remining distance can also be used in other examples.

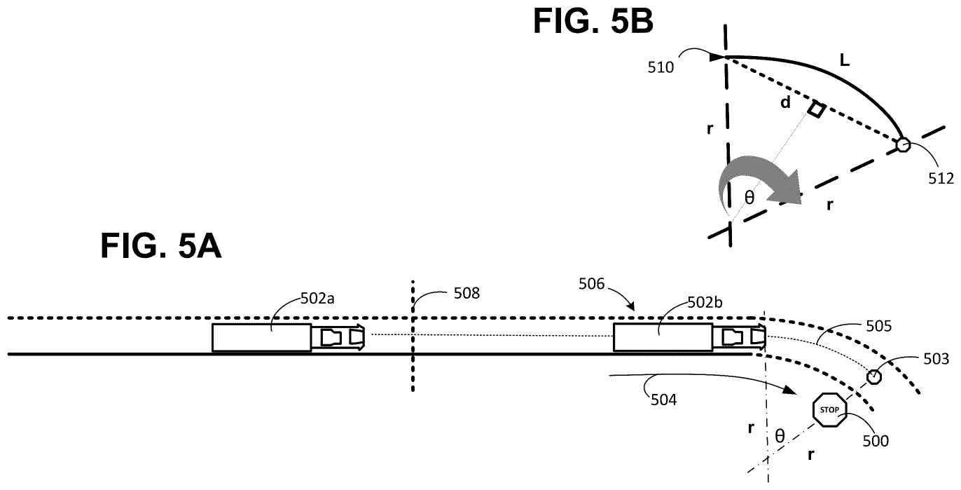

Referring to FIGS. 5A-5B, diagrams of an exemplary analysis of another detection threshold distance 501 determination in step 302 when the relevant stop sign object 500, which corresponds to a required stopping location 503, is along a path of travel for the vehicle 502 that is at least partially curved (direction of travel in the direction of arrow 504) is illustrated. In this example, the method of estimating the first remaining distance is used for a straight portion of the path of travel and an arc length calculation is used for a curved portion of the path of travel. Specifically, an arc length calculation in accordance with the below Haversine formula is used for the curved portion 505 of the path of travel based on the current position, e.g., current position 506 of the vehicle 502 and the required stopping location 503:

$$Given : d [ m ] = Haversine distance of Ego position ( t = 0 ) to required stopping location$$

$$Given : r [ m ] = \frac{1}{SAPP\_val \_StCurvature} = \frac{1}{Steering Curvature Signal [ 1 / m ]}$$

$$d = chord length = 2 * r * sin ( \frac{θ}{2} )$$

$$θ = 2 * {sin}^{- 1} ( \frac{d}{2 * r} )$$

$$L = r * θ$$

In brief, the above-mentioned methodology can be used in conjunction with retrievable maps with infrastructure reference, where identified roads can be divided into various segments for determination of road radius and curvature. In embodiments, the ratio between a substantially straight and a curved portion can be determined, and differential action can be taken as a function of said ratio. In other embodiments, differential action may be a function of individual (i.e., precise) numbers. FIG. 5B illustrates r, θ, L, and d, in relation to the illustration of vehicle path of travel shown in FIG. 5A. In embodiments, the above-referenced methodology for determining remaining distance to a required stopping location is relied upon when it is determined or inferred that the radius of a circle corresponding to a portion of the curved region is between 500-10,000 m. In embodiments, the map database for which information is retrieved, includes reliable information regarding road curvature. In some situations, road curvature data may not be available, for one reason or another. In such a case, road curvature can be detected based on, e.g., a certain steering angle greater than a threshold steering angle. This information can be used via the SSAI device 104, at least in part, to control a braking operation as herein disclosed. Other methods for determining or estimating the first remaining distance can also be used in other examples.

In some embodiments, discussed with particular reference to the methodologies of FIGS. 4-5B, a vehicle may have one or more active stability control operations running in parallel to the unintended entry into an intersection avoidance system of the present disclosure. There may be scenarios where a particular deceleration rate cannot be exceeded, and in such cases it is to be understood that thresholds for when to initiate the methodology can be adjusted to compensate the restrictions imposed by the active stability control operations.

Shown for reference at FIG. 5A is calibrated detection threshold distance 508 (e.g., similar to 404 at FIG. 4), along with r, and 0, in reference to the same designations shown at FIG. 5B. FIG. 5B illustrates ego position just prior to entry into a curve 510 and required stopping location in current lane 512 (corresponding to required stopping location 503 at FIG. 5B). L at FIG. 5B corresponds to curved portion 505 of the path of travel depicted at FIG. 5A.

In some embodiments, maximum deceleration along a curved portion of a path of vehicle travel may be capped at a predetermined deceleration rate. In embodiments, the predetermined deceleration rate is about −3 m/s². In embodiments, the predetermined deceleration rate cap is between about −2 m/s² and −4 m/s². In embodiments, emergency braking, as herein described, is not conducted on a curved portion of a vehicle path of travel approaching an stop sign/intersection.

Referring back to FIG. 3, if the SSAI device 104 determines in step 302 that the detection threshold distance has not been reached, then the method returns to step 300 and the SSAI device 104 continues monitoring the first remaining distance. However, if the SSAI device 104 determines in step 302 that the detection threshold has been reached, then the method proceeds to step 304.

In step 304, the SSAI device 104 outputs an optical warning, which can be via the instrument panel display device 106, for example. The optical warning is effectively a pre-warn phase in which a symbol is illuminated on the instrument panel display device 106, but no active braking measures occur. Accordingly, the SSAI device 104 outputs the optical warning upon determining the detection threshold distance from the stop sign object has been reached based on the monitored first remaining distance to inform the vehicle operator of the imminent stop sign object and associated intersection.

In step 306, the SSAI device 104 determines a predicted stopping distance based on a current vehicle velocity, vehicle weight, and/or environmental variables, and haptic and/or emergency braking deceleration rates for the vehicle. While the example described with reference to FIG. 3 includes emergency braking in the active braking cascade, in other examples, the active braking cascade includes haptic braking without emergency braking. For example, as discussed above, when the path of vehicle travel includes a curve, emergency braking may not be employed. Accordingly, entry conditions for method 300 can include a determination of whether or not to factor in an emergency braking phase into the predicted stopping distance calculation. In some examples, the haptic braking phase and/or emergency braking phase of the active braking cascade have calibrated or predefined time periods (or maximum time periods). Based on the current vehicle velocity, vehicle weight, and/or environmental variables the calibrated deceleration rates, and/or the haptic and/or emergency braking time periods, the SSAI device 104 determines the predicted stopping distance.

The vehicle weight and/or environmental variables can be manually input to the SSAI device 104 via an interface to that device, and/or obtained by the SSAI device 104 via one or more sensors. For example, rain sensors used for automatic wiper operation can be coupled to the communication network 102 and used by the SSAI device 104 to adjust the predicted stopping distance determined in step 306. In embodiments, a vehicle mass estimator can be running in the background and can be capable to estimate vehicle mass with, e.g., less than about 5% error. For example, a stopping distance compensation factor may be relied upon in the predicted stopping distance determination, such that the predicted stopping distance is adjusted as a function of the monitored condition or conditions. As one representative and non-limiting example, particular windshield wiper speeds may correspond to a particular predicted stopping distance compensation factor used to adjust/compensate a predicted stopping distance determination. Vehicle weight can be used in other examples. Other types and/or another number of factors can also be used, optionally in a weighted formula, to facilitate the determination of the predicted stopping distance in embodiments.

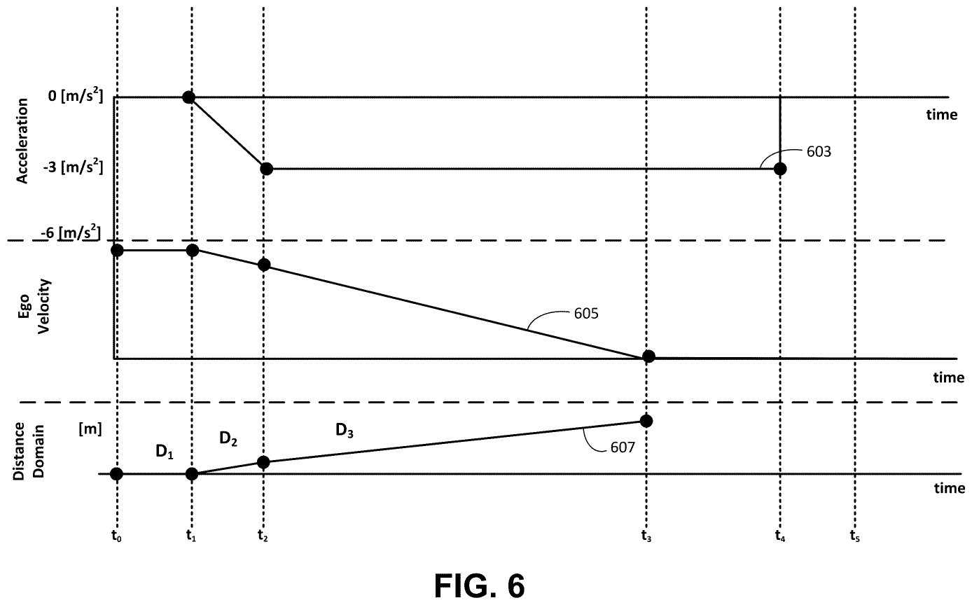

Referring to FIG. 6, depicted is a diagram of an exemplary predicted stopping distance calculation for an active braking cascade that includes haptic braking in absence of an emergency braking phase. For example, such as situation may occur when the SSAI device 104 determines, based on one or more monitored vehicle, environmental, and/or geological (e.g., presence of curve) parameters. FIG. 6 depicts plot 603, illustrating vehicle deceleration over time, plot 605, illustrating vehicle velocity, over time, and plot 607, illustrating distance of vehicle travel, over time.

At time t0, the SSAI device begins a determination of stopping distance based on monitored parameters including but not limited to current vehicle velocity, current vehicle acceleration, one or more environmental parameters (e.g., presence of and/or extent thereof, of rain, wind, snow, ice, sleet, hail, and the like), one or more geological parameters (road grade, road curvature, etc.). Based on the above-mentioned input parameters, a haptic braking command at time t1 ramps current acceleration/deceleration level to the haptic braking deceleration command by time t2. Accordingly, between time t1 and t2, vehicle velocity as shown at plot 605 decreases, and the vehicle travels some distance, as shown by plot 607. Between time t2 and t4, the haptic braking command is maintained at about −3 m/s², and the vehicle continues to slow (plot 605) for some amount of distance (plot 607), until the vehicle is stopped at time t3. Thus, the predicted stopping distance is determined by the SSAI device based on the sum of distances traveled for each portion of a haptic braking operation.

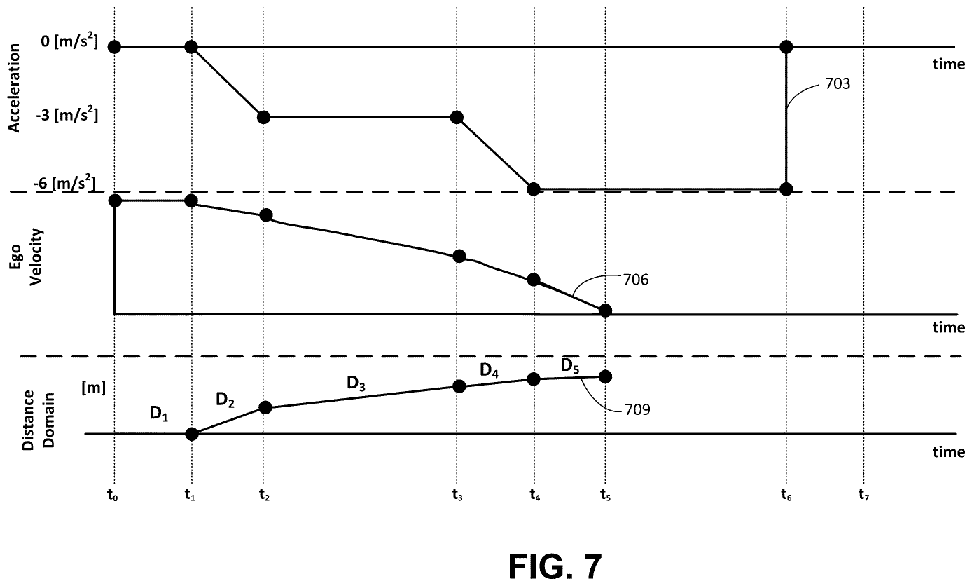

Turning now to FIG. 7, depicted is a diagram of an exemplary predicted stopping distance calculation for an active braking cascade that includes haptic and emergency braking. This example depicts plot 703, illustrating vehicle deceleration, over time; plot 706, illustrating vehicle velocity, over time; and plot 709, illustrating distance of vehicle travel, over time.

At time t0, similar to that discussed above with regard to FIG. 6, the SSAI device begins a determination of stopping distance based on monitored parameters including but not limited to current vehicle velocity, current vehicle acceleration, one or more environmental parameters (e.g., presence of and/or extent thereof, of rain, wind, snow, ice, sleet, hail, and the like), one or more geological parameters (road grade, road curvature, etc.). In this example, the SSAI device determines that reliance on emergency braking is permitted, that is there are no determined restrictions preventing the use of an emergency braking phase. Additionally, in embodiments it may be determined that haptic braking alone may not be sufficient to ensure, with some level of confidence, that the vehicle can be brought to a halt within a predicted stopping distance.

Between t1 and t2, the SSAI device initiates haptic braking. In embodiments, −3 m/s² deceleration is commanded and the deceleration ramps to the commanded value. Haptic braking continues at a constant deceleration rate between time t2 and t3. At time t3, emergency braking is commanded. In embodiments, and as shown, emergency braking corresponds to a deceleration of about −6 m/s². The deceleration ramps to the commanded deceleration between time t3 and t4, and emergency braking continues at a constant deceleration rate between time t4-t6. During each deceleration phase as shown (plot 703), the vehicle velocity decreases (plot 706). Distances traveled for each phase of the braking procedure are summed to yield a predicted stopping distance comprising both a haptic and an emergency braking phase. In the timeline shown at FIG. 7, the vehicle comes to a halt at time t5. Thus, the predicted stopping distance is determined by the SSAI device based on the sum of distances traveled for each portion of a haptic braking operation and emergency braking operation.

In embodiments, the SSAI device 104 can select a timeframe for which a haptic braking phase is commanded, as compared to an emergency braking phase. In other words, for a particular vehicle stopping routine, there can be a ratio of haptic braking time to emergency braking time. In embodiments, the desired ratio can be selected within some tolerated range of options, based on a comfort level of a driver, desired level to which vehicle degradation (e.g., rate of brake pad degradation) over time is minimized, and the like. In one representative example, a driver may prefer to avoid emergency braking at all, whenever possible. In such an example, one or more parameters of the disclosed system for preventing unintended entry into an intersection can be modified, to accommodate the request. For example, the calibrated detection threshold (e.g., 404, or 508) may be set further out from the required stopping location such that the chances of emergency braking being initiated are reduced or avoided altogether.

In embodiments, emergency braking may be commanded in lieu of a haptic braking command, in order to ensure the vehicle comes to a halt within a desired distance based on current vehicle operating conditions. In embodiments, even in such a case the SSAI device 104 may command a minimum haptic braking phase prior to shifting to the emergency braking phase for the remainder of the commanded action. In embodiments, the minimum time is about 500-1000 milliseconds, for example about 800 milliseconds. In embodiments, transitions between no braking via the SSAI device 104 and SSAI device-controlled haptic braking, and between haptic braking and corresponding emergency braking, can take between about 300-800 milliseconds. Accordingly, a minimum haptic braking phase that includes a ramp and minimum constant portion is about 800 millisecond, but can extend to about 1.5-1.8 seconds in examples.

Referring back to FIG. 3, in step 308, the SSAI device 104 determines a second remaining distance to the stop sign object based on the detection threshold distance (e.g., 404) and a vehicle distance traveled since the determination in step 302 that the detection threshold distance was reached. The distance traveled can be determined based on data obtained from the wheel speed sensor(s) 112 and an odometry calculation that is relatively granular and accurate as compared to the GPS method used to determine remaining distance because the detection threshold distance was reached.

Accordingly, the second remaining distance can be determined by subtracting the distance traveled from the detection threshold distance. Optionally, a stopping margin representing a predefined distance (e.g. between 0-2 meters, optionally more, for example between 2-3 meters) from the stop sign object can also be used to determine the second remaining distance and to ensure that the vehicle does not go beyond a particular stopping location (e.g., stopping location 503). Other methods for determining the predicted stopping distance and/or the second remaining distance can also be used in other examples.

In step 310, the SSAI device 104 determines whether a PONR has been reached. The PONR in some examples is determined based on a comparison of the second remaining distance to the stop sign object to the predicted stopping distance. In embodiments, the PONR determination is based, at least in part, on an indication of vehicle speed at a time at which the second remaining distance determination is performed. In embodiments, the predicted stopping distance determination (i.e., one or both of haptic and/or emergency braking as herein disclosed) can be adjusted as a function of the second remaining distance. Likewise, in such an example, haptic and/or emergency braking phases can be adjusted correspondingly, responsive to an actual active cascade of haptic and/or emergency braking being commanded. If the predicted stopping distance is greater than, equal to, or within a predefined margin, of the second remaining distance, then the SSAI device 104 determines that the vehicle may not come to a halt at or before a particular stopping location (e.g., stopping location 503) unless the remainder of the active braking cascade, that is, some determined combination of haptic and/or emergency braking, is commanded. If the SSAI device 104 determines that the PONR has not been reached, the method returns to step 306 and the SSAI device 104 continues to determine and compare the predicted stopping distance (which can be adjust/compensated based on vehicle parameters such as vehicle speed, distance traveled since the initial prediction, etc.) and second remaining distances. However, if the SSAI device 104 determines in step 310 that the PONR has been reached, then the method proceeds to step 312.

At step 312, the SSAI device 104 outputs an audible warning via the audio output device 118 as an indicator that the PONR has been reached. Additionally, the SSAI device 104 communicates with the ABS controller 108 to actuate haptic braking, optionally after a predefined time (e.g., 0.8 seconds or another determined average minimum response time for vehicle operators) has expired. Haptic braking, as discussed herein, refers to an intermittent or sequential braking that has a lower deceleration rate (e.g., about 3 m/s²) than emergency braking (e.g., about 6 m/s²). While the audible warning is output after the PONR has been reached in this example, in other examples, the audible warning can be output a predefined time before the PONR is reached. For example, the SSAI device 104 may store instructions that, when executed, cause the device to predict whether a PONR is likely to be reached within some predetermined time (e.g., between 1-20 seconds). The prediction can be based on one or more of current vehicle velocity, distance traveled since the calibrated detection threshold was reached, time taken for the vehicle to travel between the point at which the calibration detection threshold was reached and a current time, etc. Accordingly, in embodiments the outputting of the audible warning and the commanding of the initiation of haptic braking can occur substantially simultaneously. In additional or alternative examples, the audible warning and the commanding of the initiation of haptic braking may occur at two points separated in time, for example by 1, 2, 3, 4, 5, 6, 7, 8, 9, 10, 11, 12, 13, 14, 15, 16, 17, 18, 19, or 20 seconds, or even more, for example between 20-30 seconds.

In embodiments, the methodology for avoiding unintended entry of a vehicle into an intersection can be indirectly inhibited by a vehicle operator using the brake pedal. This can be, in embodiments, because the PONR calculation can be affected when the vehicle decelerates due to the vehicle operator requesting braking. Accordingly, in such embodiments, vehicle speed may be reduced via vehicle operator intervention, such that the PONR calculation is lower than the threshold needed to activate the SSAI device-based braking operation. This can enable the vehicle operator to regain vehicle control. In embodiments where the PONR calculation remains above the threshold needed to activate the SSAI device-based braking operation, that is, the PONR has been determined to have been reached, then even if the driver is requesting additional braking, the SSAI device-based braking operation may continue.

Proceeding to step 314, the SSAI device 104 determines whether a calibrated or predefined haptic braking time period has elapsed. In embodiments, the haptic braking time period comprises an adjustable period of time based on relevant vehicle parameters, such as those described at length herein. Examples include but are not limited to vehicle operator comfort level, presence or absence of curves or other geological features which impact the use of emergency braking, environmental conditions, road grade, etc. At 314, it is to be understood that the haptic braking time period includes both the ramp phase, and the constant phase, that is the ramp and corresponding holding time at about −3 m/s². If the SSAI device 104 determines that the haptic braking time period has not elapsed, then the method returns to step 314, and the SSAI device 104 continues to judge whether the haptic braking time period has elapsed, while continuing to command the haptic braking operation, optionally including one or more of optical and/or audible warnings. Responsive to an indication that the haptic braking time period has elapsed, the method proceeds to step 316, where the emergency braking phase is actuated.

Briefly, discussion of FIG. 3 herein includes a scenario where the PONR determination was arrived at based on both a haptic braking phase and an emergency braking phase. In other words, the PONR determination can be based on a haptic braking phase alone, or an emergency braking phase substantially alone. For example, as mentioned throughout, in other examples similar methodology can be used where a haptic braking operation is commanded in lieu of an emergency braking operation. In some examples, an emergency braking operation is commanded in lieu of a haptic braking operation. In some examples where an emergency braking operation is commanded in lieu of a haptic braking operation, control operations may be such that a minimum time haptic braking phase is included, during the proceeding to the emergency braking deceleration rate (e.g., about −6 m/s²).

Returning to step 316, the SSAI device 104 communicates with the ABS controller 108 to actuate emergency braking. For example, a deceleration rate of about −6 m/s² may be commanded. In some examples, the haptic and/or the emergency braking phases of the active braking cascade can be aborted based on satisfaction of acceleration criteria. For example, the acceleration criteria can be based on a depression of the accelerator pedal beyond a certain threshold (e.g., 80%) that indicates relatively high confidence of an operator intention during an active braking phase. In another example, the abort criteria can be based on the rate of change of the accelerator pedal exceeding a threshold (e.g., an accelerator pedal dynamic threshold) within a particular time period (e.g., 120 milliseconds). Other abort criteria can be used in other examples.

At step 318, the SSAI device 104 determines whether the vehicle has come to a halt. In embodiments, the determination at step 318 is made via data obtained from the wheel speed sensor(s) 112 or another sensor coupled to the vehicle. If the vehicle has not yet come to a halt, and the routine is not otherwise aborted or discontinued, then the method returns to the respective step of braking where said braking operation continues.

Responsive to an indication that the vehicle is stopped, the method ends. In embodiments, the SSAI device 104 may hold the vehicle in a stopped condition for a predetermined time duration. A vehicle operator may exit the method by pressing the accelerator pedal, or other action that satisfies methodology exit criteria. In this way, the active braking cascade results in the vehicle stopping at a specified stopping location. By ensuring the vehicle stops at the specified stopping location, adverse interactions between the vehicle and other biological or man-made objects can be avoided. In embodiments, as discussed herein, the vehicle stops within some predetermined distance margin before a stop sign object.

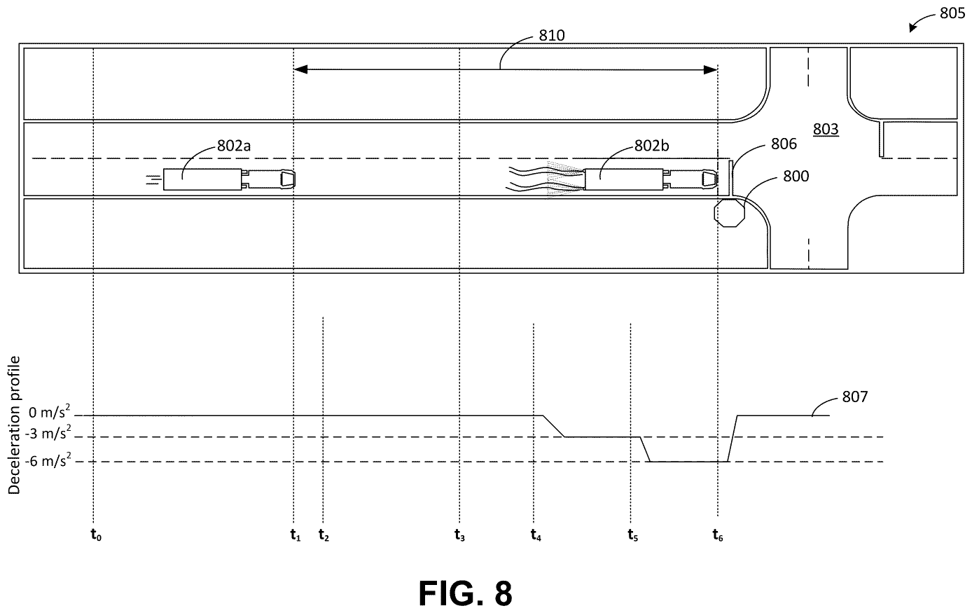

Turning now to FIG. 8, a timeline of an exemplary method for unintended intersection entry prevention is illustrated. Specifically, plot 805 illustrates motion of a vehicle 802 (802a/b), where vehicle 802a and vehicle 802b are the same vehicle at different times, along a roadway 803 from a top-down view, and plot 807 depicts a corresponding vehicle deceleration profile of the vehicle 802. In this example, at time to the SSAI device 104 starts tracking the first remaining distance via GPS upon identifying the stop sign object 800 associated with the upcoming intersection along the vehicle path of travel. In this example, and as shown at FIG. 8, there are no other vehicles or other obstructions in the path of the vehicle 802a. Accordingly, the system 100 and included SSAI device 104 are prioritized over existing active braking assistance systems configured to detect and respond to objects in the path of the vehicle.

After the SSAI device 104 determines the calibrated detection threshold distance (e.g., 404) at time t1 is reached, the SSAI device 104 outputs an optical warning, and optionally an audible warning, between time t1 and t2. Furthermore, beginning at time t1, wheel sensor(s) are relied upon for determining distance traveled since time t1. Distance remaining from the vehicle to the stop sign object 800 and corresponding required stopping location 806 is represented by distance 810. This distance 810 can be determined based on distance traveled since reaching time t1, in other words, by subtracting the distance from time t1 with vehicle distance traveled since time t1 as determined e.g., via odometry (e.g., see junction 1204). At time t3, the SSAI device 104 determines that the PONR has been reached, outputs an audible warning (optionally additionally including an optical warning), and, after a predefined delay (e.g., 0.5-1.5 seconds, for example about 0.8 seconds) between time t3 and t4, actuates a haptic braking routine at time t4. Between time t4 and t5, deceleration rate is commanded to a first deceleration rate associated with haptic braking (e.g., about −3 m/s²). At time t5, following expiration of the haptic braking phase, an emergency braking phase commences, and between time t5 and t6 a second deceleration rate (e.g., about −6 m/s²) is commanded via the SSAI device 104. While not explicitly shown, the vehicle velocity decreases proportional to the commanded rate of decelerations. The vehicle comes to a halt just before (e.g., within a particular predetermined distance margin of) the required stopping location 806, at time t6.

The SSAI device 104 then determines that the haptic braking time period (i.e., 1.4 second in this particular example) has elapsed and actuates emergency braking to cause the vehicle 802 to come to a stop in advance of a stopping margin distance of the identified stop sign object 800. In examples in which the disclosed methodology includes haptic braking only, the SSAI device 104 can actuate the haptic braking earlier and for a longer period of time in order to ensure the vehicle 802 stops in advance of the intersection.

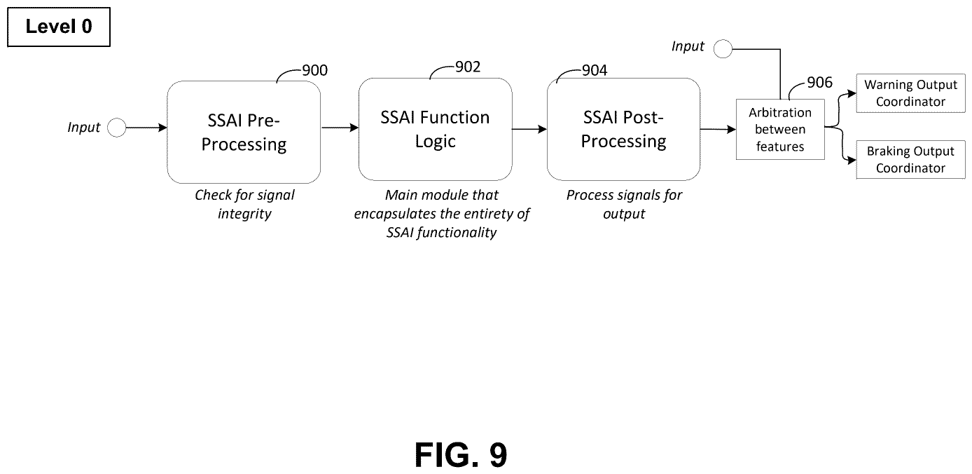

Referring to FIGS. 9-15, block diagrams of an exemplary SSAI model architecture are illustrated. Referring more specifically to FIG. 9, the SSAI model architecture in this example includes a pre-processor 900, a main logic module 902, a post-processor 904, and an arbitration module 906, which prioritizes SSAI (e.g., over other cross traffic assist features of a vehicle) before sending warning and braking requests to the appropriate coordination modules (e.g., instrument panel display device 106, audio output device 118, or ABS controller 108). In embodiments, the main logic module 902 includes one or more components of the SSAI device 104 as shown at FIG. 2. In embodiments, one or more of pre-processor 900, main logic module 902, post-processor 904, and arbitration module 906 comprise one or more components of the SSAI device 104.

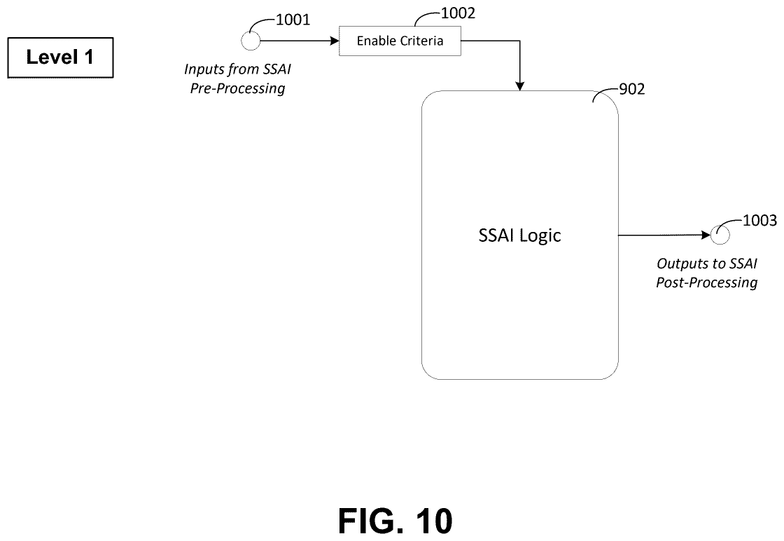

Referring more specifically to FIG. 10, prior to the activation of SSAI, the vehicle condition is checked against a list of enabling criteria via enablement criteria module 1002. Enablement criteria has been described herein with respect to the methodology disclosed, and in particular with regard to FIG. 3. Briefly, enablement criteria can include but is not limited to an indication of a working imaging device 116, ability to reference map database 208, confirmation the vehicle is traveling forward, road gradient within a predetermined range, road curvature along the current vehicle path of travel within predetermined curvature bounds, temperature within a threshold temperature range, confirmation that image recognition system are enabled to allow for reliance on the self-learning module capable to add new stop sign objects to existing map database 208, and the like. Other enabling conditions are also considered, as explained in more detail above. As shown, inputs from SSAI pre-processing 1001 feed into the enablement criteria module 1002, which judges whether conditions are met for activation of SSAI logic 902. SSAI logic 902 outputs to SSAI post-processing module(s) 1003.

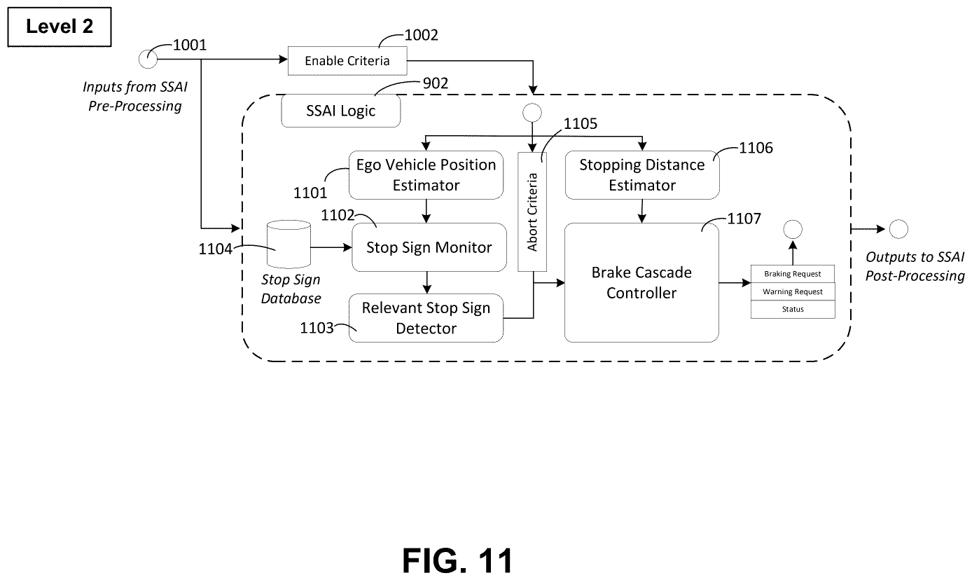

Referring more specifically to FIG. 11, shown is an embodiment of SSAI logic 902 module architecture. SSAI logic module 902 includes the following modules: ego vehicle position estimator module 1101, stop sign monitor module 1102; relevant stop sign detector module 1103; stop sign database 1104, stopping distance estimator module 1106, and brake cascade controller module 1107. The abort criteria module judges whether one or more inputs (e.g., accelerator depression past a certain threshold percentage of 100% depression) have been received that are capable to abort the SSAI device-controlled methodology. The modules in the SSAI logic module 902 together include the following responsibilities: [1] continuous monitoring of the current vehicle position utilizing GPS signal and high-resolution wheel speed sensor(s) 112 (e.g., substantially via ego vehicle position estimator module 1101), [2] continuous access to the on-board map database 208, which optionally contains both hard-coded and learned positions (e.g., substantially via stop sign database 1104 and/or stop sign monitor module 1102), [3] determination of the relevant stop sign object with the consideration of current vehicle position to the object and GPS position characteristics (latitude/longitude/bearing) (e.g., some combination of the ego vehicle position estimator module 1101, stop sign monitor module 1102, relevant stop sign detector module 1103, and/or stop sign database 1104), [4] continuous monitoring of relevant stop sign object, [5] continuous calculation of predicted stopping distance relative to current vehicle speed (e.g., substantially via stopping distance estimator module 1106), [6] determination of warning and braking states when PONR has been reached (e.g., in conjunction with brake cascade controller module 1107 amongst others), [7] continuous monitoring of braking phases of active braking cascade (e.g., in conjunction with brake cascade controller module 1107 amongst others, and [8] ready to abort when abort criteria has been satisfied (e.g., substantially via abort criteria module 1105). Brake cascade controller module 1107 outputs braking requests, warning requests (i.e., optical, audible), and provides status updates.

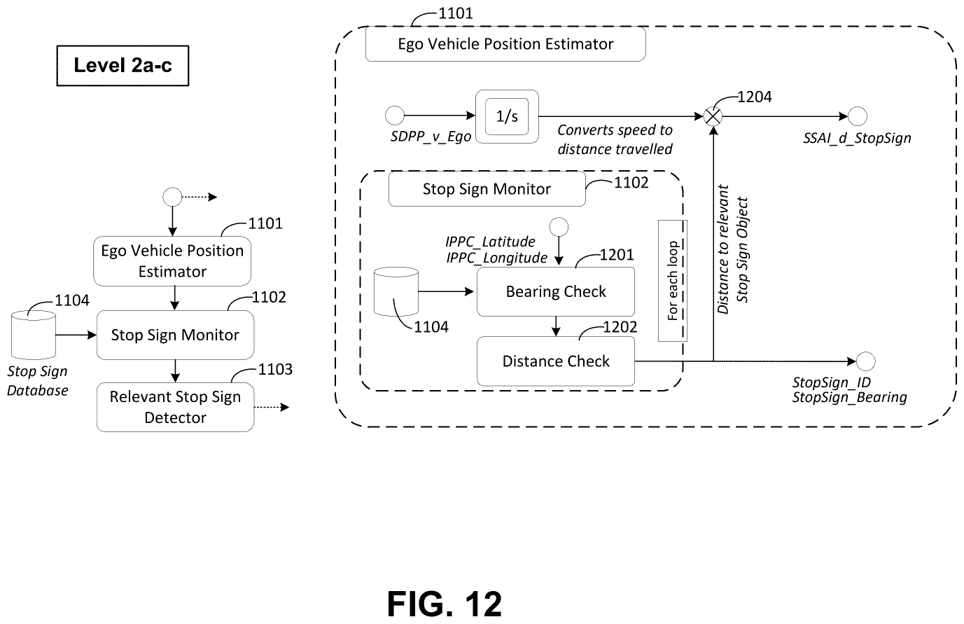

Referring more specifically to FIG. 12, the SSAI device 104 is configured to check the current position of the vehicle against the map database 208. For each object in the map database 208, the SSAI device 104 searches for the object that meets a bearing threshold via the bearing check module 1201 and is the closest. The identified object is deemed as the relevant stop sign object. The distance traveled by the vehicle is subtracted with the estimated distance (e.g., in conjunction with the distance check module 1202) to this relevant stop sign object to obtain the second remaining distance to relevant stop sign object.

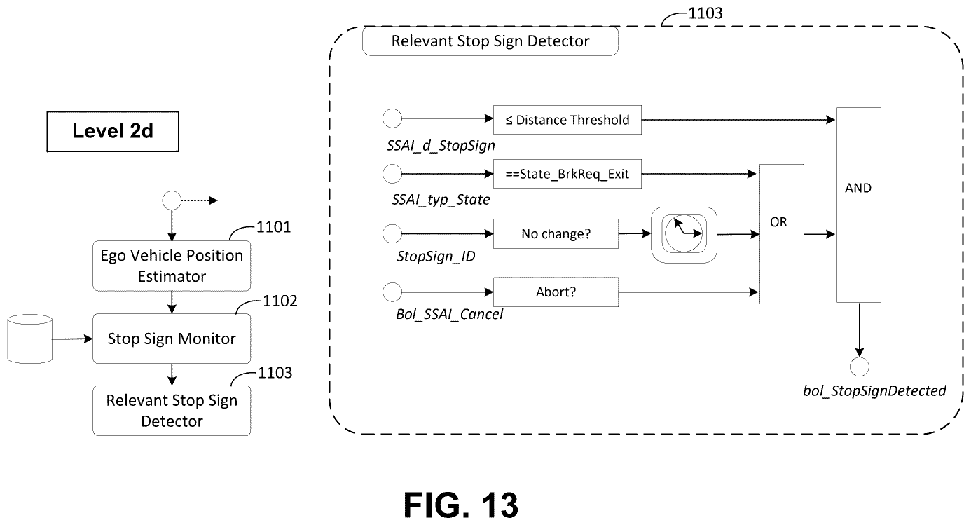

Referring to FIG. 13, details of the architecture of the relevant stop sign detector 1103 are shown in more granular detail than in the above FIGS. 11-12. In embodiments, the SSAI device 104 can have a ghost mode in which vehicle estimation and relevant stop sign object monitoring is active, but where haptic/emergency braking are not active. In embodiments, warning cascades can be active but actual haptic and/or emergency braking phases are not. In embodiments, both warning cascades and haptic/emergency braking phases are not active in the ghost mode. An active relevant stop sign detection is needed to initiate warning and active braking. In ghost-mode, the brake phase signals do not get reset because the vehicle has not come to a standstill, which the SSAI device 104 can resolve as illustrated in FIG. 13, which illustrates the modules of the relevant stop sign detector module 1202. In embodiments, such a mode can be used in vehicle systems that include braking systems and methodology discussed herein, but the braking aspects of the methodology may not be activated as yet. Accordingly, braking may not be applied via e.g., the methodology of FIG. 3, but the vehicle operating conditions may be monitored, data may be collected and analyzed. For example, the methodology of FIG. 3 may run in the background, and vehicle events including but not limited to emergency braking as conducted solely via a vehicle operator, may be recorded. Braking events requested by a vehicle operator may be correlated with substantially similar braking events that are requested by the SSAI device (but not actuated in real-world scenario), to ensure that the system is functioning as desired prior to activation thereof.

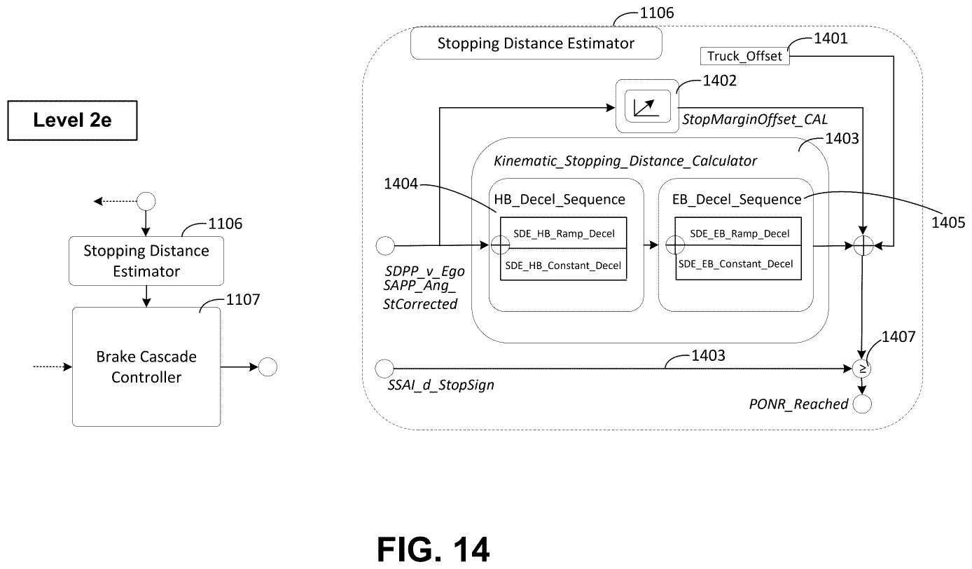

Turning to FIG. 14, depicted is stopping distance estimator 1106, which feeds into brake cascade controller 1107. The architecture can include but is not limited to truck offset 1401, stopping margin calibrated table(s) 1402, kinematic stopping distance calculator 1403, which includes haptic braking sequence module 1404 and emergency braking sequence module 1405. Haptic braking sequence module 1404 includes modules for calculating/determining deceleration ramp times and constant deceleration hold times. Similarly, emergency braking sequence module 1405 includes modules for calculating/determining deceleration ramp times and constant deceleration hold times. The stopping distance estimator 1106 includes various functionalities, including but not limited to the following. In embodiments, the SSAI device 104, by way of the stopping distance estimator 1106, can calculate a kinematic stopping distance for haptic and emergency braking durations. In embodiments, kinematic stopping distance for haptic braking but not emergency braking, can be determined. In embodiments, kinematic stopping distance for emergency braking, but not haptic braking, may be determined. In some examples where just emergency braking parameters are determined, that is an emergency braking scenario is required with no real requirement for a haptic braking phase, the system may still require a minimal haptic braking period, as discussed in greater detail herein. In embodiments, the SSAI device 104 accesses a calibrated stopping margin table with varying stopping margins for various vehicle speed intervals (e.g., about 20, about 30, about 40, about 50, about 60 mph, between about 10-20 mph, between about 20-30 mph, between about 30-40 mph, between about 40-50 mph, between about 50-60 mph, etc.). In embodiments, the SSAI device 104 accesses an offset parameter (e.g., via truck offset module 1401) to account for the position of the GPS device 110 to the front of the vehicle. In embodiments, the SSAI device 104 in conjunction with the stopping distance estimator retrieves the e.g., first and/or second remaining distance to the relevant stop sign object via Haversine/wheel odometry estimation. In embodiments, the SSAI device 104, via junction 1407, judges whether the PONR has been reached, by comparing inputs received from junction 1408, and determined distance to a stop sign object (e.g., inputs along path 1409 to junction 1407). In embodiments the stopping distance estimator 1106 portion of the SSAI device 104, sets a PONR flag based on Boolean logic set forth via the architecture of the stopping distance estimator 1106 depicted at FIG. 14 and as described in detail throughout this disclosure.

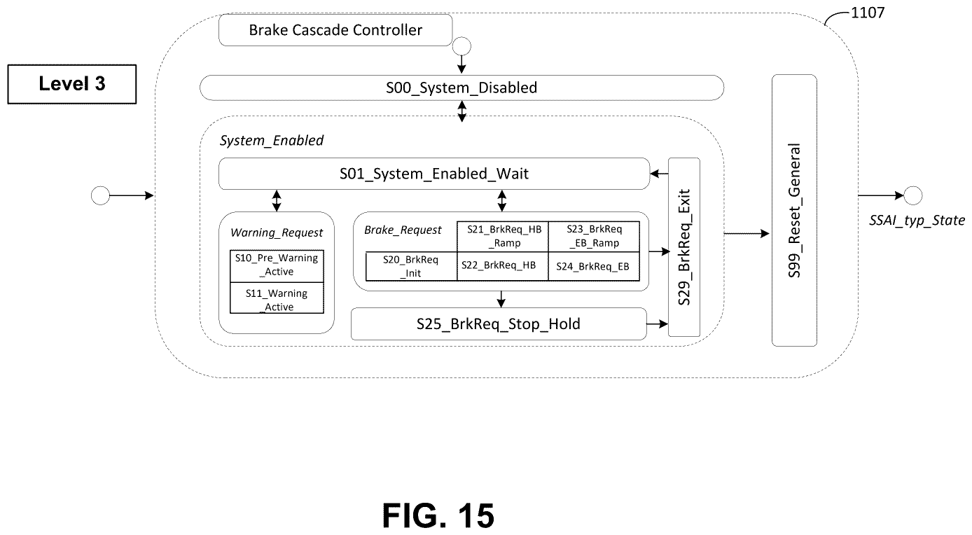

Turning now to FIG. 15, illustrated is exemplary architecture of the brake cascade controller 1107, understood as herein disclosed as part of the SSAI device 104. Brake cascade controller 1107 can, in embodiments, determine whether SSAI is enabled, initiate one or more optical and/or audible warnings at determined time points as discussed herein, and actuates haptic and, in embodiments, emergency braking via requests to the ABS controller 108, as well as exits the braking request phase and resets subsequent to a stop and hold phase for the vehicle.

With the technology, an improved active braking cascade advantageously detects stop sign objects and can ensure that a vehicle will stop before a required stopping location. The unintended entry to an intersection avoidance system disclosed herein provides an optical and acoustic warning phase followed by a haptic braking and, optionally, an emergency braking phase that engages the attention of the vehicle operator to ensure the vehicle operator appreciates the current situation and is aware of potential upcoming braking requests commanded via the SSAI device. The timing of the phases of the active braking cascade of this technology is advantageously determined based on a PONR determination, haptic and/or emergency braking ramp and hold periods, and associated deceleration rates, in order to more effectively reduce a likelihood that the vehicle will not undesirably come to a halt at any position past the required stopping location.

The methods, devices, and systems described herein can enable one or more methods, devices, and systems. In a first aspect, a method for preventing unintended vehicle entry into an intersection comprises predicting that a vehicle may not come to a halt at a stopping location associated with a stop sign object along a path the vehicle is currently traveling unless a braking operation is commanded; issuing an alarm to alert an operator of the vehicle that the braking operation is commencing or is about to commence; and actuating the braking operation to bring the vehicle to a halt at the stopping location. In a first example of the method, the method further includes wherein the stopping location is associated with the intersection; and wherein bringing the vehicle to a halt at the stopping location includes completely stopping the vehicle at or within a predetermined distance range before the stopping location along the path the vehicle is currently traveling. A second example of the method optionally includes the first example, and further includes wherein the predetermined distance range is less than 2 meters. A third example of the method optionally includes any one or more or each of the first and second examples, and further includes wherein predicting that the vehicle may be unable to come to a halt at the stopping location further comprises identifying the stop sign object, and determining the stopping location based on a position of the stop sign object. A fourth example of the method optionally includes any one or more or each of the first through third examples, and further includes wherein identification of the stop sign object is based on retrieval of a map that includes traffic signs comprising stop signs. A fifth example of the method optionally includes any one or more or each of the first through fourth examples, and further includes wherein identification of the stop sign object is based on detection of the stop sign object via an imaging system of the vehicle. A sixth example of the method optionally includes any one or more or each of the first through fifth examples, and further comprises, in conjunction with the imaging system: recognizing and classify objects as stop sign objects; determining that a particular stop sign object is not in included in the map; and updating the map with the particular stop sign object. A seventh example of the method optionally includes any one or more or each of the first through sixth examples, and further includes wherein the alarm includes at least one of an audible alarm or an optical alarm. An eighth example of the method optionally includes any one or more or each of the first through seventh examples, and further includes wherein predicting that the vehicle may not come to a halt at the stopping location further comprises: determining, based on at least one of a first braking parameter or a second braking parameter, a stopping distance as a function of one or more vehicle, environmental, or geological parameters; and wherein the braking operation comprises at least one of the first braking parameter or the second braking parameter. A ninth example of the method optionally includes any one or more or each of the first through eight examples, and further includes wherein the one or more vehicle parameters comprise a current vehicle velocity, vehicle gross weight, or vehicle windshield wiper status. A tenth example of the method optionally includes any one or more or each of the first through ninth examples, and further includes wherein the one or more environmental parameters comprise a level or type of precipitation in atmosphere and/or a level of buildup on a surface of road along the path the vehicle is currently traveling. An eleventh example of the method optionally includes any one or more or each of the first through tenth examples, and further includes wherein the one or more geological parameters comprise road grade, road curvature, or road surface. A twelfth example of the method optionally includes any one or more or each of the first through eleventh examples, and further includes wherein the first braking parameter corresponds to a haptic braking operation, characterized as a commanded vehicle deceleration of a first deceleration rate. A thirteenth example of the method optionally includes any one or more or each of the first through twelfth examples, and further includes wherein the first deceleration rate is between about −2 m/s² and about −4 m/s². A fourteenth example of the method optionally includes any one or more or each of the first through thirteenth examples, and further includes wherein the first deceleration rate is about −3 m/s². A fifteenth example of the method optionally includes any one or more or each of the first through fourteenth examples, and further includes wherein the second braking parameter corresponds to an emergency braking operation, characterized as a commanded vehicle deceleration of a second deceleration rate. A sixteenth example of the method optionally includes any one or more or each of the first through fifteenth examples, and further includes wherein the second deceleration rate is between about −5 m/s² and about −10 m/s². A seventeenth example of the method optionally includes any one or more or each of the first through sixteenth examples, and further includes wherein the second deceleration rate is about −6 m/s². An eighteenth example of the method optionally includes any one or more or each of the first through seventeenth examples, and further comprises prior to predicting that the vehicle may not come to a halt at the stopping location, issuing an optical warning to alert the operator of the vehicle that a detection threshold distance has been reached by the vehicle along the path the vehicle is currently traveling. A nineteenth example of the method optionally includes any one or more or each of the first through eighteenth examples, and further includes wherein the detection threshold distance comprises a calibrated threshold that is based on one or more of vehicle operating parameters, environmental factors, geological parameters, and/or vehicle operator preferences.

In a second aspect, a method for stopping a vehicle at a stopping location comprises monitoring a first remaining distance from the vehicle to a stop sign object; outputting an optical alert subsequent to determining a detection threshold distance from the stop sign object has been reached, the detection threshold distance based at least in part on the first remaining distance; determining a second remaining distance from the vehicle to the stop sign object, the second remaining distance less than the first remaining distance; determining a predicted stopping distance based on a predetermined set of braking operation parameters; comparing the second remaining distance to the predicted stopping distance to determine whether a point of no return (PONR) has been reached; and actuating a braking operation responsive to a determination that the PONR has been reached to ensure that the vehicle stops within a predetermined distance before reaching the stopping location. In a first example of the method, the method further comprises outputting the optical alert responsive to a current vehicle speed being above a predetermined threshold speed. A second example of the method optionally includes the first example, and further comprises identifying the stop sign object via a global positioning system (GPS) device couped to the vehicle, and via geolocation of the stop sign object in a map database, wherein monitoring the first remaining distance is via the GPS device based on the geolocation of the stop sign object. A third example of the method optionally includes any one or more or each of the first and second examples, and further includes wherein the predetermined set of braking operation parameters include a first braking phase and/or a second braking phase. A fourth example of the method optionally includes any one or more or each of the first through third examples, and further includes wherein the predetermined set of braking operation parameters includes the first braking phase and not the second braking phase. A fifth example of the method optionally includes any one or more or each of the first through fourth examples, and further includes wherein the first braking phase comprises a first commanded vehicle deceleration rate, the second braking phase comprises a second commanded vehicle deceleration rate; and wherein the first commanded vehicle deceleration rate is less than the second commanded vehicle deceleration rate. A sixth example of the method optionally includes any one or more or each of the first through fifth examples, and further includes wherein the first commanded vehicle deceleration rate is between about −2 m/s² and about −4 m/s²; and wherein the second commanded vehicle deceleration rate is between about −5 m/s² and −7 m/s². A seventh example of the method optionally includes any one or more or each of the first through sixth examples, and further includes wherein actuating the braking operation includes controlling the vehicle to decelerate at the first commanded vehicle deceleration rate, or a combination of the first commanded deceleration rate and the second commanded vehicle deceleration rate. An eighth example of the method optionally includes any one or more or each of the first through seventh examples, and further includes wherein actuating the braking operation includes controlling the vehicle to decelerate at the first commanded vehicle deceleration rate for a first time duration, followed by controlling the vehicle to decelerate at the second commanded vehicle deceleration rate for a second time duration. A ninth example of the method optionally includes any one or more or each of the first through eighth examples, and further includes wherein the first braking phase includes a first ramp portion and a first constant portion; and wherein the second braking phase includes a second ramp portion and a second constant portion. A tenth example of the method optionally includes any one or more or each of the first through ninth examples, and further includes wherein the predicted stopping distance is determined further as a function of one or more of vehicle parameters, environmental parameters, and/or geological parameters. An eleventh example of the method optionally includes any one or more or each of the first through tenth examples, and further comprises subsequent to the vehicle reaching the detection threshold distance, determining the second remaining distance as a function of the detection threshold distance minus another distance the vehicle has traveled since the detection threshold distance. A twelfth example of the method optionally includes any one or more or each of the first through eleventh examples, and further includes wherein the other distance traveled by the vehicle since the detection threshold distance is determined via data retrieved from one or more wheel speed sensors. A thirteenth example of the method optionally includes any one or more or each of the first through twelfth examples, and further comprises outputting an audible alert, optionally in combination with the optical alert, to alert an operator of the vehicle that the PONR has been reached and that the braking operation is commanded or will be commanded within a predetermined time frame. A fourteenth example of the method optionally includes any one or more or each of the first through thirteenth examples, and further comprises outputting the audible alert responsive to a prediction that the PONR will be reached within 5 seconds, 4 seconds, 3 seconds, 2 seconds, 1 second, or less. A fifteenth example of the method optionally includes any one or more or each of the first through fourteenth examples, and further comprises aborting the method via depression of an accelerator pedal to at least about 80% fully depressed.

In a third aspect, disclosed is a stop sign awareness at intersections (SSAI) device, comprising a memory having instructions stored thereon; and at least one processor coupled to the memory and configured to execute the stored instructions to cause the SSAI device to carry out any one of the examples according to the first aspect.

In a fourth aspect, disclosed is a stop sign awareness at intersections (SSAI) device, comprising a memory having instructions stored thereon; and at least one processor coupled to the memory and configured to execute the stored instructions to cause the SSAI device to carry out any one of the examples according to the second aspect.

In a fifth aspect, disclosed is an unintended entry into an intersection avoidance system, comprising a global positioning system (GPS) device coupled to a vehicle, a brake system controller, an instrument panel display device; an audio output device, and the SSAI device according to the third aspect.

In a sixth aspect, disclosed is an unintended entry into an intersection avoidance system, comprising a global positioning system (GPS) device coupled to a vehicle, a brake system controller, an instrument panel display device; an audio output device, and the SSAI device according to the fourth aspect.

In a seventh aspect, disclosed is a vehicle comprising the unintended entry into an intersection avoidance system of the fifth aspect or the sixth aspect.

In an eighth aspect, a method for vehicle crash avoidance is disclosed that is implemented by a stop sign awareness at intersections (SSAI) device and includes monitoring a first remaining distance from a vehicle to a stop sign object. An optical warning is output upon determining a detection threshold distance from the stop sign object has been reached based on the monitored first remaining distance. A comparison is then made between a second remaining distance to the stop sign object and a predicted stopping distance. The second remaining distance is determined based on the detection threshold distance and a vehicle distance traveled following determination of the detection threshold distance. Additionally, the predicted stopping distance is determined based on a current vehicle velocity and a haptic braking deceleration rate for the vehicle. Haptic braking is actuated in order to prevent entry of the vehicle into an intersection associated with the stop sign object, when the comparison indicates a point of no return has been reached.

In a ninth aspect, an SSAI device is disclosed that includes memory having stored thereon instructions and at least one processor coupled to the memory and configured to execute the stored instructions to cause the SSAI device to monitor a first remaining distance from a vehicle to a stop sign object. An optical warning is output upon determining a detection threshold distance from the stop sign object has been reached based on the monitored first remaining distance. A comparison is then made between a second remaining distance to the stop sign object and a predicted stopping distance. The second remaining distance is determined based on the detection threshold distance and a vehicle distance traveled following determination of the detection threshold distance. The predicted stopping distance in this example is determined based on a current vehicle velocity and one or more of a haptic braking deceleration rate for the vehicle or an emergency braking deceleration rate for the vehicle. One or more of haptic braking or, after a haptic braking time period during which the haptic braking is actuated has elapsed, emergency braking, is actuated in order to prevent entry of the vehicle into an intersection associated with the stop sign object, when the comparison indicates a point of no return has been reached.

In a tenth aspect, a vehicle crash avoidance system is disclosed that includes a global positioning system (GPS) device coupled to a vehicle, an antilock brake system (ABS) controller, an instrument panel display device, an audio output device, and an SSAI device communicably coupled to the GPS device, the ABS controller, the instrument panel display device, and the audio output device. The SSAI device in this example includes memory storing instructions and a map database and at least one processor coupled to the memory and configured to execute the stored instructions to cause the SSAI device to monitor a first remaining distance to a stop sign object along a path of travel of a vehicle using the GPS device and a geolocation of the stop sign object obtained from the map database. The instrument panel display device is then instructed to output an optical warning upon determining a detection threshold distance from the stop sign object has been reached based on the monitored first remaining distance.

A second remaining distance to the stop sign object is then compared to a predicted stopping distance. The second remaining distance is determined based on the detection threshold distance and a vehicle distance traveled following determination of the detection threshold distance. The predicted stopping distance is determined based on a current vehicle velocity and one or more of a haptic braking deceleration rate for the vehicle or an emergency braking deceleration rate for the vehicle. Additionally, the vehicle distance traveled following determination of the detection threshold distance is determined via odometry. The ABS controller is then instructed to actuate one or more of haptic braking or, after an audible warning is output via the audio output device, emergency braking, in order to prevent entry of the vehicle into an intersection associated with the stop sign object, when the comparison indicates a point of no return has been reached.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

1. A method for preventing unintended vehicle entry into an intersection, comprising:
predicting that a vehicle may not come to a halt at a stopping location associated with a stop sign object along a path the vehicle is currently traveling unless a braking operation is commanded;
issuing an alarm to alert an operator of the vehicle that the braking operation is commencing or is about to commence; and
actuating the braking operation to bring the vehicle to a halt at the stopping location.

2. The method according to claim 1, wherein the stopping location is associated with the intersection; and:
wherein bringing the vehicle to a halt at the stopping location includes completely stopping the vehicle at or within a predetermined distance range before the stopping location along the path the vehicle is currently traveling.

3. The method according to claim 2, wherein the predetermined distance range is less than 2 meters.

4. The method according to claim 1, wherein predicting that the vehicle may be unable to come to a halt at the stopping location further comprises:
identifying the stop sign object, and determining the stopping location based on a position of the stop sign object.

5. The method according to claim 4, wherein identification of the stop sign object is based on retrieval of a map that includes traffic signs comprising stop signs.

6. The method according to claim 4, wherein identification of the stop sign object is based on detection of the stop sign object via an imaging system of the vehicle.

7. The method according to claim 6, further comprising, in conjunction with the imaging system:
recognizing and classify objects as stop sign objects;
determining that a particular stop sign object is not in included in the map; and
updating the map with the particular stop sign object.

8. The method according to claim 1, wherein the alarm includes at least one of an audible alarm or an optical alarm.

9. The method according to claim 1, wherein predicting that the vehicle may not come to a halt at the stopping location further comprises:
determining, based on at least one of a first braking parameter or a second braking parameter, a stopping distance as a function of one or more vehicle, environmental, or geological parameters; and
wherein the braking operation comprises at least one of the first braking parameter or the second braking parameter.

10. The method according to claim 9, wherein the one or more vehicle parameters comprise a current vehicle velocity, vehicle gross weight, or vehicle windshield wiper status.

11. The method according to claim 9, wherein the one or more environmental parameters comprise a level or type of precipitation in atmosphere and/or a level of buildup on a surface of road along the path the vehicle is currently traveling.

12. The method according to claim 9, wherein the one or more geological parameters comprise road grade, road curvature, or road surface.

13. The method according to claim 9, wherein the first braking parameter corresponds to a haptic braking operation, characterized as a commanded vehicle deceleration of a first deceleration rate.

14. The method according to claim 13, wherein the first deceleration rate is between about −2 m/s2 and about −4 m/s2.

15. The method according to claim 13, wherein the first deceleration rate is about −3 m/s2.

16. The method according to claim 9, wherein the second braking parameter corresponds to an emergency braking operation, characterized as a commanded vehicle deceleration of a second deceleration rate.

17. The method according to claim 16, wherein the second deceleration rate is between about −5 m/s2 and about −10 m/s2.

18. The method according to claim 17, wherein the second deceleration rate is about −6 m/s2.

19. The method according to claim 1, further comprising:
prior to predicting that the vehicle may not come to a halt at the stopping location, issuing an optical warning to alert the operator of the vehicle that a detection threshold distance has been reached by the vehicle along the path the vehicle is currently traveling.

20. The method according to claim 19, wherein the detection threshold distance comprises a calibrated threshold that is based on one or more of vehicle operating parameters, environmental factors, geological parameters, and/or vehicle operator preferences.

21. A method for stopping a vehicle at a stopping location, comprising:
monitoring a first remaining distance from the vehicle to a stop sign object;
outputting an optical alert subsequent to determining a detection threshold distance from the stop sign object has been reached, the detection threshold distance based at least in part on the first remaining distance;
determining a second remaining distance from the vehicle to the stop sign object, the second remaining distance less than the first remaining distance;
determining a predicted stopping distance based on a predetermined set of braking operation parameters;
comparing the second remaining distance to the predicted stopping distance to determine whether a point of no return (PONR) has been reached; and
actuating a braking operation responsive to a determination that the PONR has been reached to ensure that the vehicle stops within a predetermined distance before reaching the stopping location.

22. The method of claim 21, further comprising:
outputting the optical alert responsive to a current vehicle speed being above a predetermined threshold speed.

23. The method of claim 21, further comprising:
identifying the stop sign object via a global positioning system (GPS) device couped to the vehicle, and via geolocation of the stop sign object in a map database, wherein monitoring the first remaining distance is via the GPS device based on the geolocation of the stop sign object.

24. The method according to claim 21, wherein the predetermined set of braking operation parameters include a first braking phase and/or a second braking phase.

25. The method according to claim 24, wherein the predetermined set of braking operation parameters includes the first braking phase and not the second braking phase.

26. The method according to claim 24, wherein the first braking phase comprises a first commanded vehicle deceleration rate, the second braking phase comprises a second commanded vehicle deceleration rate, wherein the first commanded vehicle deceleration rate is less than the second commanded vehicle deceleration rate.

27. The method according to claim 26, wherein the first commanded vehicle deceleration rate is between about −2 m/s2 and about −4 m/s2; and wherein the second commanded vehicle deceleration rate is between about −5 m/s2 and −7 m/s2.

28. The method according to claim 26, wherein actuating the braking operation includes controlling the vehicle to decelerate at the first commanded vehicle deceleration rate, or a combination of the first commanded deceleration rate and the second commanded vehicle deceleration rate.

29. The method according to claim 28, wherein actuating the braking operation includes controlling the vehicle to decelerate at the first commanded vehicle deceleration rate for a first time duration, followed by controlling the vehicle to decelerate at the second commanded vehicle deceleration rate for a second time duration.

30. The method according to claim 24, wherein the first braking phase includes a first ramp portion and a first constant portion; and
wherein the second braking phase includes a second ramp portion and a second constant portion.

31. The method according to claim 21, wherein the predicted stopping distance is determined further as a function of one or more of vehicle parameters, environmental parameters, and/or geological parameters.

32. The method according to claim 21, further comprising:
subsequent to the vehicle reaching the detection threshold distance, determining the second remaining distance as a function of the detection threshold distance minus another distance the vehicle has traveled since the detection threshold distance.

33. The method according to claim 32, wherein the other distance traveled by the vehicle since the detection threshold distance is determined via data retrieved from one or more wheel speed sensors.

34. The method according to claim 21, further comprising:
outputting an audible alert, optionally in combination with the optical alert, to alert an operator of the vehicle that the PONR has been reached and that the braking operation is commanded or will be commanded within a predetermined time frame.

35. The method according to claim 34, further comprising:
outputting the audible alert responsive to a prediction that the PONR will be reached within 5 seconds, 4 seconds, 3 seconds, 2 seconds, 1 second, or less.

36. The method according to claim 21, further comprising:
aborting the method via depression of an accelerator pedal to at least about 80% fully depressed.

37. A stop sign awareness at intersections (SSAI) device, comprising:
a memory having instructions stored thereon; and
at least one processor coupled to the memory and configured to execute the stored instructions to cause the SSAI device to:
carry out the method according to claim 1.

38. A stop sign awareness at intersections (SSAI) device, comprising:
a memory having instructions stored thereon; and
at least one processor coupled to the memory and configured to execute the stored instructions to cause the SSAI device to:
carry out the method according to claim 21.

39. An unintended entry into an intersection avoidance system, comprising:
a global positioning system (GPS) device coupled to a vehicle;
a brake system controller;
an instrument panel display device;
an audio output device; and
the SSAI device according to claim 38, wherein the stored instructions, when executed by the at least one processor, further cause the SSAI device to carry out the method according to claim 1.

40. An unintended entry into an intersection avoidance system, comprising:
a global positioning system (GPS) device coupled to a vehicle;
a brake system controller;
an instrument panel display device;
an audio output device; and
the SSAI device according to claim 38, wherein the stored instructions, when executed by the at least one processor, further cause the SSAI device to carry out the method according to claim 21.

41. A vehicle, comprising the unintended entry into an intersection avoidance system of claim 39.
